(19) United States
(12) Patent Application Publication
(10) Pub. No.: US 2021/0247300 A1
(43) Pub. Date: Aug. 12, 2021

(54) DEVICE FOR MONITORING GAS EMISSIONS AND DETERMINING CONCENTRATION OF TARGET GAS

(71) Applicant: 1829340 Alberta Ltd., Calgary (CA)

(72) Inventor: Yonathan Dattner, Calgary (CA)

(21) Appl. No.: 17/161,592

(22) Filed: Jan. 28, 2021

Related U.S. Application Data
(60) Provisional application No. 62/971,395, filed on Feb. 7, 2020.

(51) Int. Cl. G01N 21/3504; G01N 21/27

(52) U.S. Cl. CPC G01N 21/3504; G01N 2021/3536; G01N 21/27

(57) ABSTRACT

An emission monitoring device is for measuring concentration of a target gas. The emission monitoring system comprises a gas cell, a radiation source, a detector, a readout circuit, and a controller. In response to a first event, the controller causes the radiation source to enter a first operational mode and the readout circuit to sample and hold a first output signal while the radiation source is operating in the first operational mode. In response to a second event, the controller causes the radiation source to enter into a second operational mode and the readout circuit to obtain a difference between the first output signal and a second output signal, the second output signal of being detected while the radiation source is operating in the second operational mode, wherein the controller converts the difference into an output value representing the concentration of the target gas.

### CROSS-REFERENCE TO RELATED APPLICATIONS

This application claims the benefit of priority of U.S. Provisional Application No. 62/971,395 filed Feb. 7, 2020, which is incorporated herein by reference.

### BACKGROUND OF THE INVENTION

### (1) Field of the Invention

The invention pertains generally to sensors for detecting gas emissions. More specifically, the invention relates to an emission monitoring system for measuring the concentration of a target gas using a radiation source that emits infrared (IR) light.

### (2) Description of the Related Art

Optical absorption techniques such as non-dispersive infrared (NDIR) measurement have been recognized for many years as sensitive, stable and reliable methods of gas concentration measurement. In a typical NDIR method, the selective absorption of infrared radiation by certain gas species of interest is measured to determine the concentration of the target gas in a sample. This has a wide variety of applications—for example, NDIR measurements detecting absorption of radiation by carbon dioxide and other gases, such as carbon monoxide or hydrocarbons, are commonly used to monitor atmospheric composition or automotive exhaust, as well as in fire detectors.

A conventional NDIR instrument typically comprises a source of radiation (usually infrared), such as an incandescent lamp or another electrically heated element that serves as a blackbody emitter, e.g. a silicon carbide rod or nichrome filament; a narrow bandwidth interference filter arranged to ensure that only radiation absorbed by gas of interest is measured; a gas cell for containing a sample including the target gas of interest; and a photodetector for detecting radiation transmitted by the sample and transforming the intensity of the detected radiation into an electrical signal.

Often, the intensity of incident radiation may be modulated by a mechanical chopper or by an electrically modulated radiation source (“on and off” regime). Such a device is termed a “one channel” NDIR sensor and represents the most basic NDIR device. This type of instrument is relatively inexpensive but does not provide any kind of compensation for instrument drift over time which may occur due to the radiation source and/or the photodetector ageing, or accumulation of dirt and dust in the optical path, for example. As a result, “one channel” NDIR instruments need to be calibrated relatively often.

On the other hand, “two channel” NDIR sensors have a signal channel and a reference channel. The signal channel operates in exactly the same way as the “one channel” device describes above, with the wavelength of the band pass filter adjusted to the absorption wavelength(s) of the gas of interest. The reference channel usually works in another wavelength band, at which the target gas species does not absorb, thus providing a base line for the signal channel. The differential signal between the signal and reference channels, normalized on reference channel intensity, gives an absorption signal which is stable with respect to any intensity drift resulting from the radiation source (or detector). In typical “two channel” sensors, the source of radiation has a wide spectral output, comprising both the signal and reference wavelengths. Another type of “two channel” NDIR sensor comprises two photodetectors and includes two separate gas cells into which the emission from the radiation source is split along paths of equal lengths. One cell is filled with non-absorptive (inert) gas to provide a reference channel, and the other with the sample gas (including the gas of interest). Such sensors can work with good stability with the two channels working on the same wavelength (corresponding to an absorption line of the target gas), but the requirement for a separate, sealed gas reference cell containing an inert gas is a serious limitation in a portable, low cost design.

Existing sensors are primarily designed to operate in the near-IR range, where the absorption of most of the known fugitive gases is low. While the low absorption can be overcome by increasing the optical path length between the light source and the detectors, this is achieved with expensive and complicated optical setups such as cavity ring down spectroscopy or intracavity laser absorption, etc. Similarly, increasing the optical path length in open path systems has some limitations such as the light source can interact with and be scattered or absorbed by other particles in the other than the desired target gas, such as rain, dust or snow thus resulting in erroneous reporting of concentration of target gas. Moreover they must hit a retroreflector and stay well aligned, in many field conditions wind and other factors can shift the retroreflector causing increased maintenance requirements.

Other problems with existing sensors include power inefficiency due to the need for continuous temperature stabilization and light source or laser requirements limiting their application in remote location deployment.

### BRIEF SUMMARY OF THE INVENTION

According to an exemplary embodiment of the invention there is disclosed an emission monitoring device for measuring concentration of a target gas. The emission monitoring system comprises a gas cell, a radiation source, a detector, a readout circuit coupled to the detector, and a controller coupled to the radiation source and the readout circuit. In response to a first event occurrence, the controller is configured to cause the radiation source to enter a first operational mode and further cause the readout circuit to sample and hold a first output signal of the detector while the radiation source is operating in the first operational mode. In response to a second event occurrence, the controller is further configured to cause the radiation source to exit the first operational mode and enter into a second operational mode and further cause the readout circuit to obtain a difference between the first output signal and a second output signal of the detector, the second output signal of the detector being detected while the radiation source is operating in the second operational mode. The controller is further configured to convert the difference between the first output signal and the second output signal into an output value representing the concentration of the target gas.

According to an exemplary embodiment of the invention there is disclosed a method of measuring a concentration of a target gas. The method includes causing a radiation source to enter a first operational mode and further causing a readout circuit to sample and hold a first output signal of a detector coupled to the readout circuit while the radiation source is operating in the first operational mode. The method further includes causing the radiation source to exit the first operational mode and enter into a second operational mode and further causing the readout circuit to obtain a difference between the first output signal and a second output signal of the detector, the second output signal of the detector being detected while the radiation source is operating in the second operational mode. The method further includes converting the difference between the first output signal and the second output signal into an output value representing the concentration of the target gas.

According to an exemplary embodiment, a method of measuring a concentration of a target gas includes compressing air containing the target gas to a desired pressure in a gas cell. In this embodiment, the emission monitoring device includes a compressor to add and compress gas into a gas cell, a back pressure valve on the air output of the gas cell, and a pressure sensor within the gas cell. A controller automatically turns on the compressor, measures the pressure within the gas cell, and, when the pressure reaches a desired pressure, the controller samples a dark value and turns on a light source. Light values from one or more detectors are later read when a reference detector reaches a threshold hold amount of light. The back pressure valve is digitally controlled by the controller such that the valve is opened after measurement is complete to release the pressure within the gas cell and this process is repeated every time the system makes a measurement. Before the controller turns on the compressor, the controller digitally closes the back pressure valve.

Concerning gas value measurements, the dark measurement is taken by the controller while the compressor is adding gas into the gas cell. In other words, the dark value can happen in parallel with the gas compression operation. The dark signal is connected to a sample and hold and is charging a capacitor while the compressor builds up pressure in the gas cell. When pressure is ready, the controller controls the sample and hold control signal to go low (thereby triggering the sample and hold action) and then turns on the light source. The light source takes time to reach the desired temperature after being turned on. As the light source goes hotter, the signals on the detectors increase. The controller monitors the detector signals as the light source goes hotter and hotter until a desired value is reached on a reference detector. When the reference detector reaches a predetermined threshold, then all the rest of the detectors are sampled by the controller and those are the values used. By waiting until the reference detector reaches a threshold amount of light to trigger sampling the other detectors, the controller ensures the light source always reaches the same power flux density on the output between measurements.

An exemplary advantage of some embodiments is that the system compresses the air and gas within the gas cell thereby increasing the number of molecules and also broadening the spectral absorption lines, which both help with measuring lower concentration and not requiring longer path lengths.

An exemplary advantage of some embodiments is that the system does not need temperature compensation or stabilization. The detectors will drift with temperature but the system automatically samples a dark value to form a baseline of the measurement and a differential value is amplified with the light on.

These and other advantages and embodiments of the present invention will no doubt become apparent to those of ordinary skill in the art after reading the following detailed description of preferred embodiments illustrated in the various figures and drawings.

### BRIEF DESCRIPTION OF THE DRAWINGS

The invention will be described in greater detail with reference to the accompanying drawings which represent preferred embodiments thereof:

FIG. 1 shows a block diagram of a cross section of a gas analyzer system according to an exemplary embodiment.

FIG. 2 illustrates an exploded perspective view of the gas detection unit of the gas analyzer system of FIG. 1.

FIG. 3 shows a schematic diagram of the detector-readout circuitry of the gas analyzer system of FIG. 1.

FIG. 4 shows a block diagram of an emission monitoring system according to an exemplary embodiment.

FIG. 5 shows a block diagram of the controller of FIG. 4.

FIG. 6 illustrates a flowchart describing actions performed by the controller of FIG. 5 in determining the concentration of a target gas according to an exemplary embodiment.

FIG. 7 illustrates a flowchart describing actions performed by the controller of FIG. 5 in calibrating the emission monitoring system of FIG. 4 according to an exemplary embodiment.

FIG. 8 shows a block diagram of a smart pole for monitoring gas and tracking emissions at a site according to an exemplary embodiment.

FIG. 9 illustrates a block diagram showing a gas emissions monitoring system having a plurality of smart poles deployed at a particular site according to an exemplary embodiment.

### DETAILED DESCRIPTION

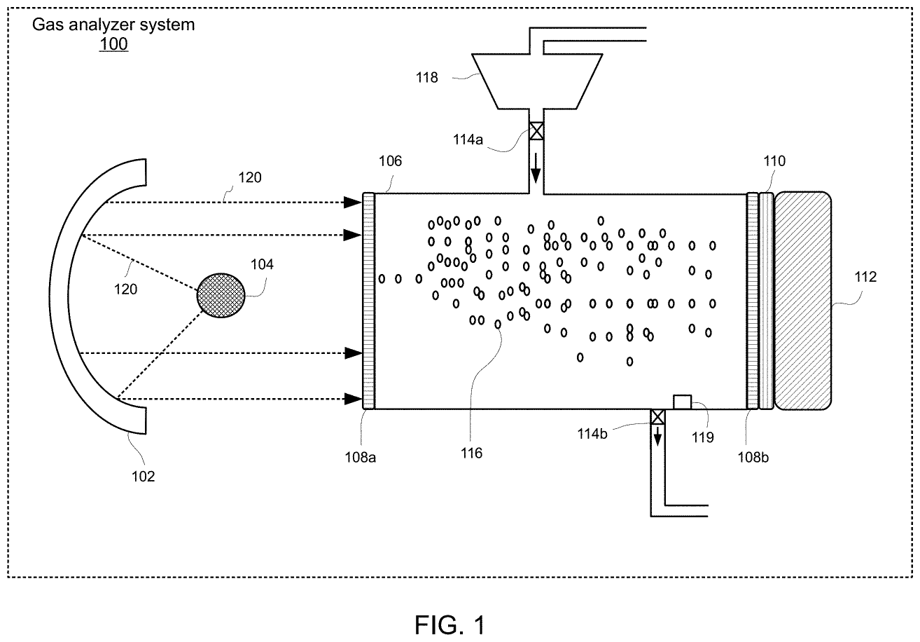

FIG. 1 shows a gas analyzer system 100 according to an exemplary embodiment. The gas analyzer system 100 comprises a parabolic reflector 102, a radiation source 104, a gas cell 106, a first germanium window 108a placed upstream of the gas cell 106, a second germanium window 108b that is located downstream of the gas cell, a filter array 110 sandwiched between the second germanium window 108b and a detector-read-out assembly 112. The gas cell further comprises an inlet check valve 114a and an outlet back pressure valve 114b via which gas molecules 116 of a target gas enter and exit the gas cell 106, respectively. The inflow and outflow of gas molecules 116 into and out of the gas cell 106 is controlled by a compressor 118 located prior the inlet valve. A pressure sensor 119 is mounted within the gas cell 106 for measuring the pressure within the cell 106.

In this embodiment, the gas analyzer system 100 is used to measure the concentration of the target gas. The gas analyzer system 100 is operable in one of two operational modes—dark mode and light mode. In the dark mode, measurements are performed with the radiation source 104 off and correspond to a baseline measurement. The baseline measurement accounts for the ambient temperature inside the gas cell. When operated in the light mode, the radiation source 104 is on and emits electromagnetic (EM) radiation in the form of IR light 120a.

In the light mode, the IR light 120 incident on the parabolic reflector 102 is reflected towards the gas cell 106 as indicated by the dashed lines in FIG. 1. Thereafter, the IR light 120 passes through the first germanium window 108a into the gas cell 106. The germanium windows 108a, 108b are transparent at all wavelengths. As a result, the IR light 120 originating from the parabolic reflector penetrates through the first germanium window 108a and emerges in the gas cell 106 unattenuated. The first germanium window 108a and the second germanium window 108b in this embodiment further serve as seals to prevent gas molecules 116 of the target gas within the gas cell 106 from escaping to the atmosphere.

Inside the gas cell 106, the gas molecules 116 are selectively excited by the IR light 120 arriving from the radiation source. This selective excitation leads to an attenuation of the intensity of the IR light and the degree of attenuation is dependent on the concentration of the target gas within the gas cell 106. In general, a higher concentration of the target gas leads to a higher degree of attenuation of the IR light and vice versa. As a result of the attenuation, only a fraction of the IR light reaches the filter array 110 located downstream of the gas cell 106.

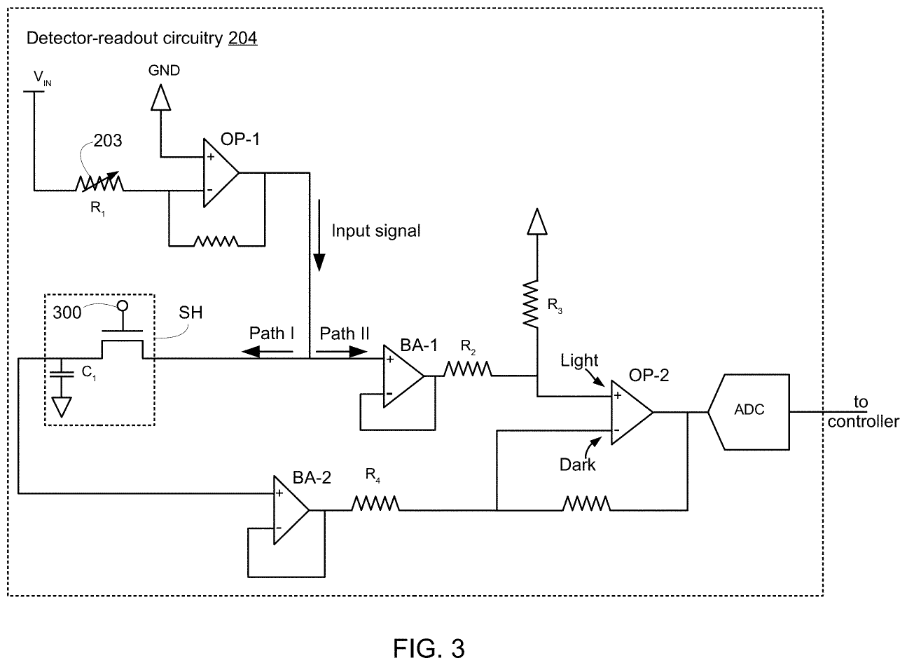

The filter array 110 contains one or more bandpass filters, each of which selectively transmits a portion of the attenuated IR light while rejecting all other wavelengths. The IR light transmitted through the one or more filters reach the detector-read-out assembly 112. In this embodiment, the detector-read-out assembly 112 comprises one or more detectors 203, each of which is coupled to a respective read-out circuitry 204a, 204b, 204c, 204d. Preferably, each detector 203 is a PbSe infrared detector that exhibits a change in its electrical resistance when illuminated with IR light of different intensities (see R₁ shown in FIG. 3). Nevertheless, any type of photodetector can also be deployed as the detector 203 in other embodiments.

In principle, one can obtain information about the concentration of the target gas inside the gas cell by relating the intensity of transmitted IR light detected by the detector-read-out assembly 204 to the intensity of IR light emitted by the radiation source 104 in accordance with the Beer-Lambert law. As earlier mentioned, the amount of IR light absorbed by the gas molecules 116 in the gas cell 106 is dictated by the concentration of the target gas present in the gas cell 106. According to the Beer-Lambert Law, the intensity I of the IR light incident on an active detector 203 decreases exponentially with the concentration of the target gas and is governed by the following equation,

I=I₀e^{-μx}, (1)
where:
I₀ is the intensity of IR light reaching the active detector 203 when the concentration of the target gas is zero,
μ is a parameter that depends on the absorption coefficient for the target gas and filter combination, and the optical path-length between the radiation source and the active detector, and
x is the concentration of the target gas.

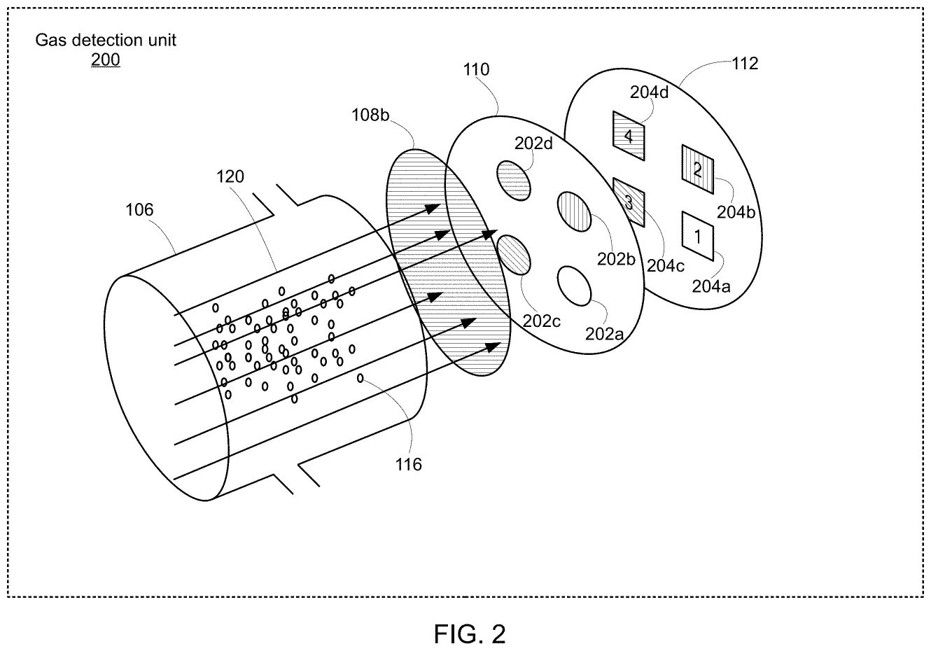

FIG. 2 illustrates an exploded perspective view of the gas detection unit 200 of the gas analyzer system 100 of FIG. 1. The gas detection unit 200 comprises the gas cell 106, the second germanium window 108b, the filter array 110 and the detector-read-out assembly 112. In this embodiment, the gas cell 106 is cylindrical in shape while the second germanium window 108b and the filter array 110 are circular wheels. The radius of the filter array 110 is equal to the radius of the cross section of the gas cell 106. The filter array 110 comprises four filters—a reference filter 202a and three other filters 202b, 202c, 202d. The four filters 202a-d are symmetrical placed relative to the centre of the filter array 110. This arrangement ensures that IR light of equal intensity reach all four filters 202a-d. In some embodiments, the reference filter 202a is configured to transmit IR light of all wavelengths, in other words, the reference filter 202a transmits the entire IR light that is incident upon it. In contrast, the other three filters in this embodiment are bandpass filters that selectively transmit only a portion of the incident IR light, the portion corresponding to a respective target gas to be measured. In other embodiments, the reference filter 202a is also a bandpass filter that selectively transmits only a portion of the incident IR light corresponding to a wavelength that is not absorbed by any gas that is likely to be present in the gas cell 106.

The detector-readout assembly 112 comprises four detectors 203 and four readout circuits 204a-d, wherein each detector 203 is coupled to a respective one of the readout circuits 204a-d in an arrangement depicted by a detector-readout circuitry 204 illustrated in FIG. 3. Each detector-readout readout circuitry 204a-d is mapped to a corresponding filter 202a-d and receives IR light transmitted by that particular filter 202a-d. For instance, the detector-readout circuitry 204a receives IR light transmitted by only the reference filter 202a and no other filters. Consequently, in this embodiment, the detector-readout circuitry 204a is referred to as a reference detector-readout circuitry. By placing the detector-readout assembly 112 in parallel with and as close as possible to the filter array 110, IR light transmitted by each one of the filters 202a-d reach a corresponding detector-readout circuitry 204a-d unattenuated. As earlier mentioned, the transmitted IR light reaching a particular detector 204a-d causes a change in the electrical resistance of that particular detector 203. It is this change in the electrical resistance that is measured and processed by the detector-readout circuitry 204.

Apart from the reference filter 202a and its corresponding reference detector-readout circuitry 204a, each one of the other filters 202b-d and corresponding detector-readout circuitry 204b-d is dedicated to a specific target gas. As an example, the gas cell may contain gas molecules of methane, carbon-dioxide, and water vapour, whereby each of the three filters 202b-d and corresponding detector-readout circuitry 204b-d is dedicated to a particular one of the three gases. In this manner, the concentration of all three gas can be determined simultaneously.

FIG. 3 shows a detector-readout circuitry 204 of the gas analyzer system 100 of FIG. 1. The detector-readout circuity 204 comprises a bias voltage V_{IN}, a variable resistor R₁, two operational-amplifiers OP-1 and OP-2, three resistors R₂, R₃ and R₄, a sample-and-hold circuit SH, two buffer amplifiers BA-1 and BA-2, and an analog-digital-converter ADC.

In this embodiment, the bias voltage V_{IN} and the variable resistor R₁ represent components of the detector 203. As earlier mentioned, the electrical resistance of the detector 203 decreases with increased illumination. In order to measure the change in the electrical resistance caused by an illumination, a bias voltage V_{IN} is applied to one end of the detector 203 causing an input signal to be generated. The input signal generated is proportional to the intensity of IR light incident on the detector 203. The input signal is generally quite small hence it is first pre-amplified by the operational-amplifier OP-1. Depending on the operational mode for which the gas analyzer system 100 is currently operating, the pre-amplified signal from operational-amplifier OP-1 can be processed along one of two Paths:
Path I: If the gas analyzer system is being operated in the dark mode, the pre-amplified signal is processed through the circuit comprising the sample-and-hold circuit SH and the buffer amplifier BA-2.
Path II: If the gas analyzer system is being operated in the light mode, the pre-amplified signal is processed through the circuit comprising the buffer amplifier BA-2 and the resistor R₂.

For instance, when the gas analyzer 100 is operated in the dark mode (i.e. with the radiation source turned off) the pre-amplified signal is sampled by the sample-and-hold circuit SH. The holding (output) signal corresponds to a dark value at the inverting (negative) input terminal of the operational-amplifier OP-2. On the other hand, when the gas analyzer is operated in the light mode, the pre-amplified signal is processed through the buffer amplifier BA-2. The output signal in this instance corresponds to a light value at non-inverting (positive) terminal of the operational-amplifier OP-2.

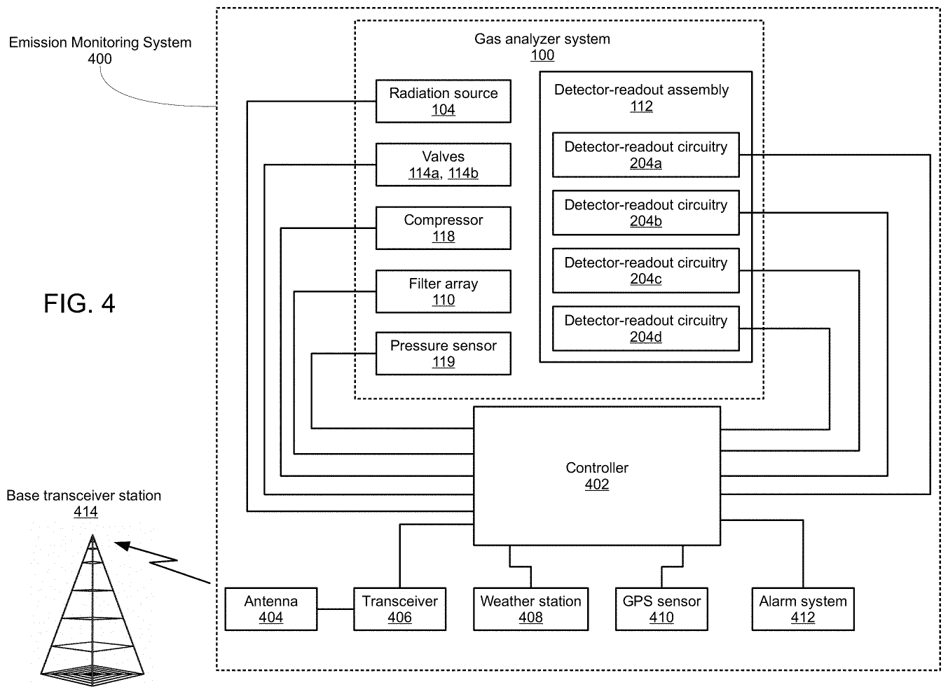

An output of the operational-amplifier OP-2 is generated from the difference between the dark value and value at the inverting and non-inverting terminals of the operational-amplifier OP-2, respectively. This output is sent as an output value to the ADC. Obtaining the differential between the light value and the dark value in this manner automatically helps account for temperature instabilities. The ADC converts the output value into a digital signal that is sent to a controller 402 (see FIG. 4) for further analysis.

FIG. 4 shows a block diagram of an emission monitoring system 400 according to an exemplary embodiment. The emission monitoring system 400 comprises a controller 402, the gas analyzer system 100 of FIG. 1, an antenna 404, a transceiver 406, a weather station 408, a GPS sensor 410, and alarm system 412. The controller 402 is communicatively coupled to the transceiver 406, the weather station 408, the GPS sensor 410, and the alarm system 412. In addition, the controller 402 is communicatively coupled to several components of the gas analyzer system 100 as shown in FIG. 4 and enables the components of the gas analyzer system to perform the various operations earlier described. For instance, by dynamically controlling the valves 114a, 114b and the compressor 118, the controller 402 regulates the inflow and outflow of gas molecules 116 within the gas cell 106. The pressure sensor 119 is coupled to the controller 402 and allows the controller 402 to determine when the pressure in the gas cell 106 reaches a threshold level. During the inflow process, the controller 402 opens the inlet check valve 114a, closes the outlet back pressure valve 114b, and activates the compressor 118 to force the flow of the target gas into the gas cell 106. Similarly, when the gas cell 106 is to be emptied, the controller opens the outlet back pressure valve 114b and optionally may also open the check valve 114a and activate the compressor 118 to purge the gas cell 106 of its original contents.

Furthermore, the controller 402 conditions the gas analyzer system 100 to a desired operational mode (i.e. light mode or dark mode) for which measurement is to be performed. This involves turning on or off the radiation source 104 and pre-configuring the detector-readout circuity 204 in order to ensure that an input signal through the detector-readout circuity 204 is processed according to the operational mode for which the gas analyzer system 100 has been pre-set i.e. ensuring that measurements performed in the dark mode are processed along Path I while measurements performed in the light mode are processed along Path II.

When a measurement has been performed and the signal processed through the detector-readout circuity 204, the controller 402 receives the digital signal from the ADC of FIG. 3 and performs further analysis in real time in order to obtain one or more parameters of interest. In this embodiment the parameters of interest are the concentration of the target gas within the gas cell 106 and the emission flux of the target gas at a particular site.

The controller 402 also provides real time feedback based on the results of the analysis. In the instance where the controller 420 determines that the concentration of the target gas at the site where the emission monitoring system 400 is deployed is greater than a predetermined threshold value, the controller 402 triggers the alarm system 412. In this embodiment, the alarm system 412 is an audio notification system that is pre-programmed to output different sounds for different target gases.

The weather station 408 provides the controller 402 with information regarding prevailing weather conditions. Information provided by the weather station includes air temperature, wind direction, wind speed, relative humidity, air pressure, etc. The controller 402 analyzes these parameters using an appropriate model in order to determine a correlation between the prevailing environmental conditions and the concentration of the target gas. This correlation is utilized by the controller 402 in monitoring, tracking and mapping of escaped gas plumes at a particular site.

The GPS sensor 410 provides the controller 402 with information about the location and elevation of the particular site where the emission monitoring system 400 is deployed. Similar to the information provided by the weather station 408, the controller 402 utilizes the information provided by the GPS sensor 410 in monitoring, tracking and mapping of escaped gas plumes at the particular site.

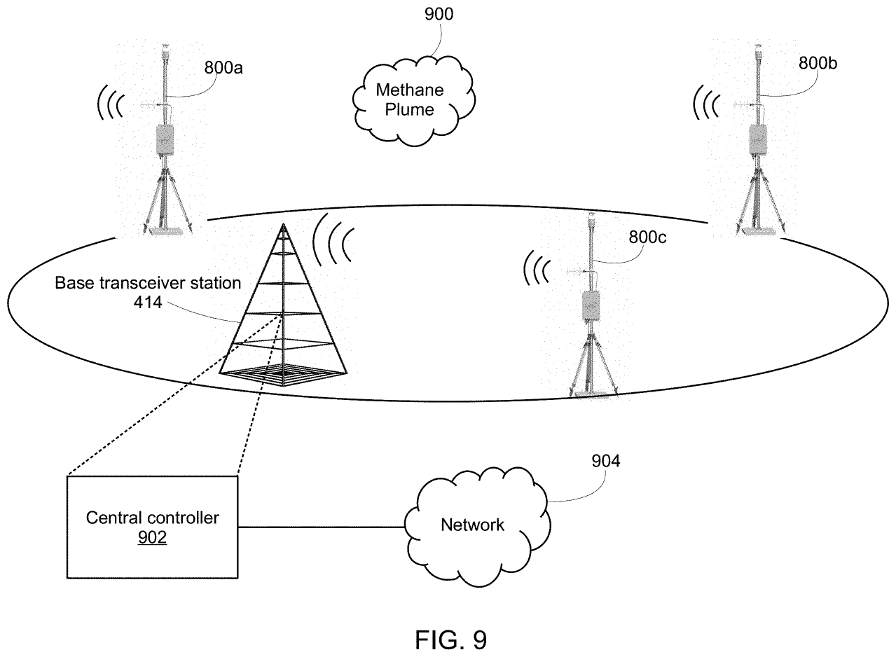

The controller 402 further performs to operation of transmitting results of the measurements performed by individual components of the emission monitoring system 400 to the base transceiver station 414 via the transceiver 406. The transceiver 406 receives digital signal from the controller 402 and converts it into radio waves at a desired frequency. The radio waves radiated by the antenna 404 are received at the base transceiver station 414 and reconverted into digital signals that are fed into a central controller 902 of the base transceiver station 414. (See FIG. 9.)

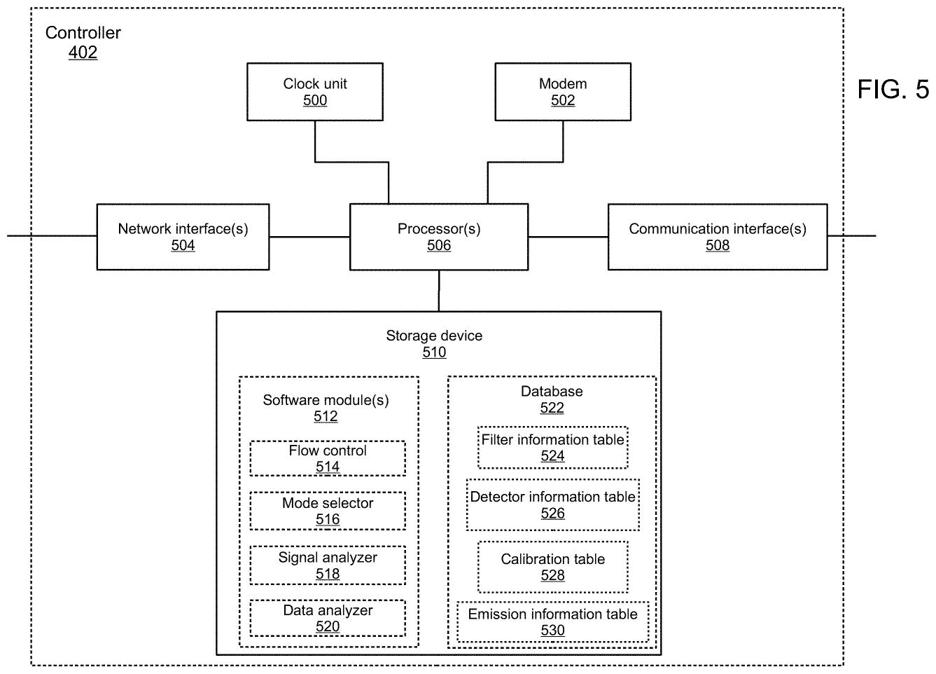

FIG. 5 shows an exemplary block diagram of the controller 402 of FIG. 4. In this embodiment, the controller 402 is a computer server running a number of software modules 512, which are stored in a storage device 510 such as a hard disk or other tangible, non-transitory computer readable medium. The storage device 510 further stores a database 522 containing a number of data tables (a filter information table 524, a detector information table 526, a calibration table 528 and an emission information table 530) utilized in conjunction with the software modules 510.

The controller 402 further includes one or more network interfaces 504 for connecting to a computer network either via a wired or wireless connection; one or more communication interfaces 508 for connecting to the components of the gas analyzer system 100, the transceiver 406, the weather station 408, the GPS sensor 410, and the alarm system 412; a real-time clock chip 500 for tracking time; a modem 502 for converting digital data into electrical signal and vice versa; and one or more processors 506 coupled to the clock unit 500, the modem 502, the network interfaces 504, the communication interfaces 508, and the storage device 510. In the following description, the plural form of the word “processors” will be utilized as it is common for a CPU of a computer server to have multiple processors 506 (sometimes also referred to as cores); however, it is to be understood that a single processor 506 may also be operable to perform the disclosed functionality in other embodiments.

In this embodiment, the modules represent software modules 512 executed by the processors 506 to cause the controller 402 to perform a variety of functions within the emission monitoring system 400. The flow control 514 regulates the inflow and outflow of gas molecules in the gas cell 106. The mode selector 516 configures the radiation source 104 for one of the operational modes of the emission monitoring system 400. The signal analyzer 518 is responsible for detecting and analyzing the signal reaching the detector-readout assembly 122. The data analyzer 520 analyzes the digital signal received from the ADC of the detector-readout circuitry 114 to thereby generate one or more parameters of interest. The data analyzer 520 contains one or models utilized by the processors 506 in the data analysis.

In another embodiment, rather than software modules 512 executed by the processors 506, the modules of FIG. 5 represent hardware modules and may be implemented either internal or external to the controller 402. Combinations of software and hardware modules may also be utilized in other embodiments.

The database 522 consists of a plurality of tables including a filter information table 524, a detector information table 526, a calibration table 528, and an emission information table 530. These tables are utilized by the processors 506 when performing various functions of the software modules 512.

In this embodiment, the filter information table 524 contains information about the bandwidth and sensitivity of the filters. This information is utilized by the processors 506 when performing an analysis of the data received from the detector-readout circuitry and in the identification of the target gas. The detector information table 526 contains information about the performance characteristics of each detector and further includes the electrical and optical characteristics. The calibration table 528 contains information utilized by the processor in calculating the absolute value of the concentration of a target gas. This information includes those obtained during a calibration process that involves measuring the intensity of IR light absorbed by a known concentration of a target gas. The emission information table 530 contains information about different target gases and their absorption spectra. This information is utilized by the processors 506 during the data analysis for generating charts of the intensity of a target gas versus the wavelength.

Further details of how the controller 402 operates in various exemplary embodiments are provided in the following.

### Measurement Process

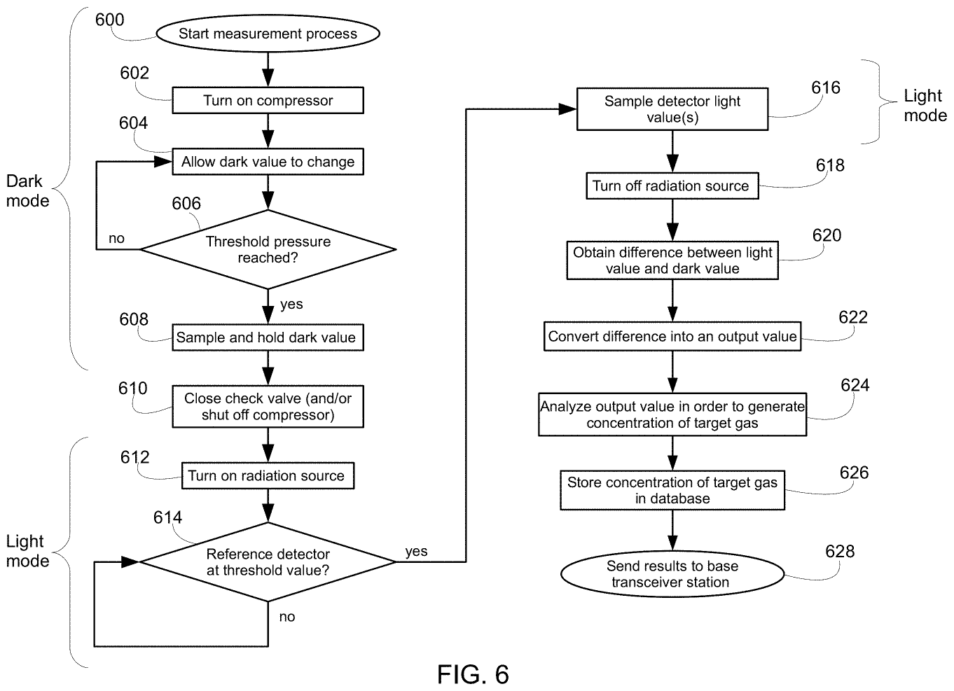

FIG. 6 illustrates a flowchart describing actions performed by the controller 402 of the emission monitoring system 400 in determining the concentration of a target gas within the gas cell 106 according to an exemplary embodiment. The steps of the flowchart are not restricted to the exact order shown, and, in other configurations, shown steps may be omitted or other intermediate steps added. In this embodiment, the processors 506 execute one or more of the modules 514, 516, 518, 520 in order to cause the controller 402 to perform the illustrated steps.

As shown in FIG. 6, the process begins at step 600 when the controller detects an event occurrence to start the measurement process. In this embodiment, the event occurrence corresponds to a predetermined time being reached indicating that a sample needs to be taken. In other embodiments, the predetermined event occurrence may correspond to the detection of a target gas within a predetermined radius of the emission monitoring system 400. Any desired starting condition may be utilized to trigger the measurement process to start at step 600.

At step 602, in response to starting the measurement process, the controller 402 prepares measurement conditions in order to determine the concentration of the target gas. This includes opening the inlet check valve 114a, and activating the compressor 118 to force an inflow of air possibly including one or more target gas(es) into the gas cell 106.

At step 604, the controller puts the gas analyzer system 100 in the dark mode by pulling high the sample and hold (SH) control signal 300. The SH control signal 300 is active low. Thus, when pulled high by the controller 402, the sample and hold circuit does not hold the input signal. Instead, the input signal from OP-1 is passed by the SH transistor and charges capacitor C1.

Once in the gas cell 106, the target gas interacts with background electromagnetic radiation. The transmitted radiation is passed through the second germanium window 108b and the filter, and reaches the detector 203 where it is processed as a first input signal through the detector-readout circuitry 204 of FIG. 3. Since the gas system analyzer 100 is operated in the dark mode, the first input signal is processed along Path I of the detector-readout circuitry. In the dark mode, both path I and path II in FIG. 3 pass the same input value and OP-2 may not detect any difference between the signals passed along the two paths. In the dark mode, the “dark” signal at OP-2 may be exactly the same as the “light” signal at OP-2. As long as the SH control signal 300 is high, the “dark” signal at OP-2 can freely change according to the detector 203.

At step 606, the controller 402 checks the pressure sensor 119 to determine whether the pressure in the gas cell 106 has reached a predetermined threshold pressure. In some embodiments, the gas cell 106 is pressurized by the compressor 118 to be a pressure approximately 80% of a maximum limit value physically allowed by the pressure cell 106. However, any predetermined pressure can be utilized in other embodiments in a similar manner. The predetermined pressure threshold may be stored within the storage device 510 during manufacture. When the controller 402 determines that the pressure within the gas cell 106 has reached the predetermined pressure threshold, control proceeds to step 608; otherwise, control returns to step 604 where the system stays in the dark mode allowing the dark signal at OP-2 to freely change.

At step 608, the controller 402 samples and holds the dark value. This is done by the controller providing an active low command 300 that triggers the sampling and holding SH of the first input signal. The command 300 controls the ON/OFF condition of the transistor of the sample-and-hold circuit and regulates the sampling and holding period of the sample-and-hold circuit SH. When the transistor of the SH circuit is closed (SH control signal 300 from controller 402 is high in the dark mode), the first input signal is allowed to pass. However, when the transistor of the SH circuit is opened (SH control signal 300 from the controller 402 is low starting at step 608), the sample-and-hold circuit SH does not pass the input signal and instead holds the previously sampled voltage on the capacitor C1, which is converted to a first output signal as a “dark” value. As long as the SH control signal 300 is held low by the controller 402, the dark value is held at the inverting terminal of the operational-amplifier OP-2.

At step 610, the controller 402 sends control signals to compressor 118 and/or inlet check valve 114a to lock in the current pressure in the gas cell 106. The actions of the controller 402 at step 610 ensure the pressure within the gas cell 106 remains substantially constant after it has reached the threshold pressure detected at step 606. In some embodiments, the compressor is configured by the controller to simply maintain the desired threshold pressure. In some embodiments, the check valve 114a only allows gas to flow into the chamber and will not allow gas to flow out of the gas chamber 106 via the inlet. The controller 402 may therefore simply shut off the compressor 118 in response to detecting the threshold pressure at step 606.

At step 612, the controller 402 turns on the radiation source 104. The IR light 120 emitted by the radiation source 104 and reflected by the parabolic reflector 102 passes through the first germanium window 108a and enters into the gas cell 106. Inside the gas cell 106, the IR light 120 interacts with the gas molecules 116 of the target gas(es). This interaction causes a finite amount of the IR light 120 to be absorbed by the gas molecules 116. The unabsorbed portion exits the gas cell 106 through the second germanium window 108b.

At step 614, the controller 402 monitors the reference detector-readout circuitry 204a to determine whether a second input signal, i.e., a light signal for the reference detector-readout circuitry 204a, has reached a predetermined threshold level. In this embodiment, the reference detector-readout circuitry 204a is measuring a wavelength of light that is not absorbed by any of the gases in the gas cell including any of the target gas(es). In this way, as the infrared radiation source 104 heats up and transmits more and more infrared light, the reference detector-readout circuitry 204a will detect a higher and higher value of the “light” signal. The controller can monitor the output of the ADC for the reference detector-readout circuitry 204a in order to determine when the output reaches a predetermined threshold that is within the higher range as supported by the ADC. For instance, the predetermined threshold may be configured such that it represents a signal difference between light and dark that is at 80% amplitude as measurable by the ADC. As before, 80% is an example of a threshold and in other embodiments and desired threshold may be utilized as long as it is within the sampling range of the ADC.

As shown in FIG. 6, the dark measurement is taken while the compressor 118 adds gas to the gas cell 106. In parallel, the dark value is being measured until the pressure in the cell 106 reaches a predetermined threshold level. The dark signal is connected to the sample and hold SH circuit and charging the capacitor C1 while the compressor 118 builds up pressure in the gas cell 106. When pressure is ready, sample and hold control signal 300 goes low and then the light source 104 goes on. After the light source 104 turns on, it takes time for it to reach the desired temperature. As the light source 104 goes hotter the signal on the detectors 203 increase. In this embodiment, the light source 104 goes hotter and hotter until a desired value is reached on the reference detector 204a at step 614. When the reference detector 204a reaches a fixed threshold then all the rest of the detectors 204b-d are sampled and those the value used by the controller 402. This ensures the light source 104 always reaches substantially a same power flux density on the output between measurements.

When the reference detector 204a has reached the predetermined threshold value, control proceeds to step 616; otherwise, the controller 402 continues to monitor the reference detector-readout circuitry 204a to wait for the desired threshold value to be reached.

At step 616, the controller samples the various values from the ADC outputs on each of the other detector-readout circuits 204b-d in order to gather the various output values representative of the amount of target gases in the gas cell. As previously mentioned, each detector-readout circuit 204b-d is focused on a particular target gas and the values sampled at step 616 correspond to the amounts of each target gas present in the gas cell 106.

At step 618, the controller 402 turns off the radiation source 104. Turning off the radiation source in this manner minimizes the energy consumed by the radiation source. The period for which the radiation source 104 is turned on in this embodiment generally corresponds to how long it takes the radiation source 104 to warm up such that the reference detector 204a reaches the predetermined threshold value at step 614. In some embodiments, the on period is approximately 10 seconds; however shorter or longer periods can be accommodated and the on period may also change over time given ambient conditions such as temperature and/or age of components.

At step 620, within each detector 204b-d targeting a specific target gas, an output of the operational-amplifier OP-2 is generated from the difference between the dark value at the inverting and the light value at the non-inverting terminals of the operational-amplifier OP-2, respectively. Thereafter, the output of the operational-amplifier OP-2 is received by the ADC.

As shown in FIG. 3, the second input signal received at step 616 is processed through the detector-readout circuitry 204. Because the second input signal was obtained in the light mode, the signal is processed along Path II of the detector-readout circuitry as earlier described. After pre-amplification of the second input signal by the operational-amplifier OP-1, the pre-amplified signal is passed through the buffer amplifier BA-1, where the output from the buffer amplifier corresponds to a light value. The light value is subsequently held at the inverting terminal of the operational-amplifier OP-2.

At step 622, within each detector 204b-d, the ADC converts the output from the operational-amplifier OP-2 into a (digital) output value.

At step 624, the controller 402 receives the output values from the ADC of each of the detector-readout circuits 204b-d and performs further analysis of the output values from the ADCs in order to determine the concentration of each target gas.

As earlier mentioned, the controller 402 utilizes the data analyzer 520 and information contained in the database 522 to perform the analysis. For each ADC output value, the analysis involves converting the output value into an intensity of IR light absorbed the target gas according to information contained in the emission information table 530; obtaining a difference between the intensity of IR light absorbed by the target gas and an intensity of IR light in a reference gas obtained during a calibration process; and normalizing the difference relative to the intensity of IR light in the reference gas in order to obtain a dimensionless quantity that is dependent on the concentration of the target gas but not the intensity of IR originating from the radiation source 104 or variations in temperature. By inputting the dimensionless quantity into a model stored in the data analyzer 520, the controller determines the concentration of the target gas.

At step 626, the controller 402 stores the concentration of the target gas calculated in step 624 in the emission information table 530.

At step 628, the controller 402 sends the results of the measurement to the base transceiver station 414 via the transceiver 406. Additional information such as measurements of the wind direction, wind speed, air temperature at the remote location, performed by the weather station 408 or more is sent to base transceiver station 414.

### Calibration Process

At a high level, the calibration process in this embodiment facilitates determining the absolute intensity of IR light 120 emitted by the radiation source 104. Furthermore, the calibration process enables determining a parameter that relates the intensity of IR light absorbed by a target gas to that emitted by the radiation source 104, which in turn facilitates determination of the concentration of the target gas.

The determination of the intensity of IR light 120 emitted by the radiation source 104 involves measuring the signal generated in the presence of an inert gas (e.g. nitrogen) as the target gas. Nitrogen gas, like other inert gases, does not absorb IR light, as such the IR light originating from the radiation source 104 arrives at the detector unattenuated despite passing through gas molecules of nitrogen within the gas cell 106. Consequently, the intensity of IR light hitting the detector is the same as the intensity of IR light 120 emitted by the radiation source 104.

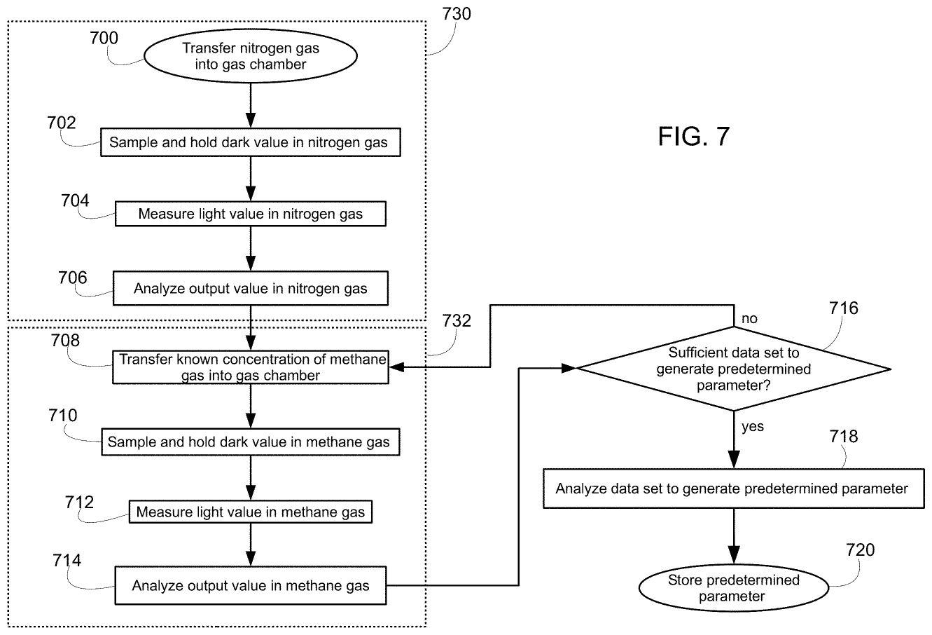

FIG. 7 illustrates a flowchart describing actions performed by the controller 402 of the emission monitoring system 400 in calibrating the emission monitoring system 400 for measuring the concentration of a target gas within the gas cell 106 according to an exemplary embodiment. The steps of the flowchart are not restricted to the exact order shown, and, in other configurations, shown steps may be omitted or other intermediate steps added. In this embodiment, the processors 506 execute one or more of the modules 514, 516, 518, 520 in order to cause the controller 402 to perform the illustrated steps.

As shown in FIG. 7, the process begins at step 700 when the controller 402 activates the transfer of nitrogen gas into the gas cell 106. This step is initiated after the controller 402 determines that the radiation source 104 is turned off (i.e. the gas analyzer system 100 is in the dark mode) and that no remnant gas is present in the gas cell 106. In the instance where the controller 402 detects the presence of remnant gas in the gas cell 106, the controller 402 opens the outlet back pressure valve 114b and activates the compressor 118b to thereby eject any remnant gas from the gas cell 106 prior to initiating with step 700. This helps to accurately determined the intensity of IR light emitted by the radiation source 104.

Returning now to FIG. 7. At step 702, the controller 402 measures the dark value in nitrogen gas. This step entails detecting an input signal through the filter on the filter array 110 and sampling the input signal by the sample-and-hold circuit SH of the detector-readout circuitry. An output signal from the sample-and-hold circuit SH is held as a dark value in nitrogen gas at the inverting terminal of the operational-amplifier OP-2 of the detector-readout circuitry.

At step 704, the controller 402 measures the light value in nitrogen gas. At this step, the controller 402 turns on the radiation source 104. The IR light 120 emitted by the radiation source 104 and reflected by the parabolic reflector 102 passes through the first germanium window 108a and enters into the gas cell 106. Since nitrogen is a noble gas, no absorption of the IR light 120 occurs inside the gas cell 106, as such the IR light 120 exits the gas cell 106 with an unattenuated intensity. Thereafter, the controller 402 turns off the radiation source 104. After passing through the filter, the unattenuated IR light irradiates the detector thereby generating an input signal that is processed along Path II of the detector-readout circuitry as earlier described. The output signal generated during the processing is held as the light value in nitrogen gas at the non-inverting terminal of the operational-amplifier OP-2.

At step 706, an output of the operational-amplifier OP-2 is generated from the difference between the dark value and light value held at the inverting and non-inverting terminals of the operational-amplifier OP-2, respectively. The output of the operational-amplifier OP-2 is received by the ADC and passed on to the controller 402, where it is further analyzed to obtain the intensity of IR light 102 emitted by the radiation source 104. The calculated intensity of IR light 102 emitted by the radiation source 104 is stored in the calibration table 528 for future use.

At step 708, the controller 402 activates the transfer of a known concentration of a target gas into the gas cell 106. In this embodiment, the target gas is assumed to be methane gas, however any gas may be utilized as long as a known concentration of the gas is transferred into the gas cell 106.

At step 710, the input signal generated by the known concentration of methane gas in the dark mode is processed along Path I of the detector-readout circuitry 204 and the output is held as a dark value in methane gas at the non-inverting terminal of the operational-amplifier OP-2. Thereafter, the controller 402 turns on the radiation source 104, causing the gas analyzer system 100 to enter into the light mode.

At step 712, the controller 402 measures the light value in methane gas. With the radiation source 104 now turned on, the input signal form the gas cell is processed through Path II after being pre-amplified by the operational-amplifier OP-1. The output signal from the buffer amplifier BA-1 is held as a light value at the non-inverting terminal of the operational-amplifier OP-2. The output of the operational-amplifier OP-2 generated from the difference between the dark value and light value is received by the ADC, which converts the output into an (digital) output value that is sent to the controller 402 for further analysis.

At step 714, the controller 402 analyzes the output value in methane gas in order to obtain to the intensity of IR light absorbed in the known concentration of methane gas. The calculated intensity of IR light absorbed in the known concentration of methane gas is stored in the calibration table 528 for future use.

At step 716, the controller 402 determines whether there are sufficient data sets in the calibration table 528 in order to generate a parameter that correlates the concentration of methane gas with the intensity of IR light absorbed in methane gas. If the data sets are sufficient to generate the parameter, control proceeds to step 718; otherwise, control returns to step 708 to perform more measurements, each time transferring a different but known concentration of methane gas into the gas cell 106.

At step 718, the controller 402 analyzes the data set stored in the calibration table 528 based on a model in the data analyzer 520 in order to determine the predetermined parameter. The calculated predetermined parameter is stored in the emission information table 530. By repeating the calibration process outlined in FIG. 7 for a plurality of gases, the emission monitoring system 400 can be configured to measure the concentration of an unknown target gas for which the system has been calibrated. For instance, in the example earlier provided, the calibration process is repeated for each one of carbon dioxide and water vapour, in addition to methane gas discussed above in order to configure the emission monitoring system 400 for measuring the concentration of methane, carbon dioxide and water vapour present in a gas plume.

As described above, the calibration process of FIG. 7 involves performing two sets 730, 732 of measurement on known gases in the gas cell 106. A first set of measurements 730, both dark and light values, is performed with only nitrogen in the gas cell 106. Thereafter, a second set of measurements 732, again both dark and light values, is performed with a known concentration of a target gas in the gas cell 106. In some embodiments, sets 730, 732 may each be described in more details similar to the full process shown in FIG. 6. For instance, the various thresholds for compressed pressure within the gas cell 106 at step 606 and waiting until the reference detector 204a reaches the threshold value at step 614 may also be performed during both set 730 and also set 732. Furthermore, additional sets similar to set 732 may be performed for any desired type of target gas. For instance, if three detectors 204b-d are utilized to detect three respective target gases, set of calibration steps 732 may be repeated three times—once for each target gas.

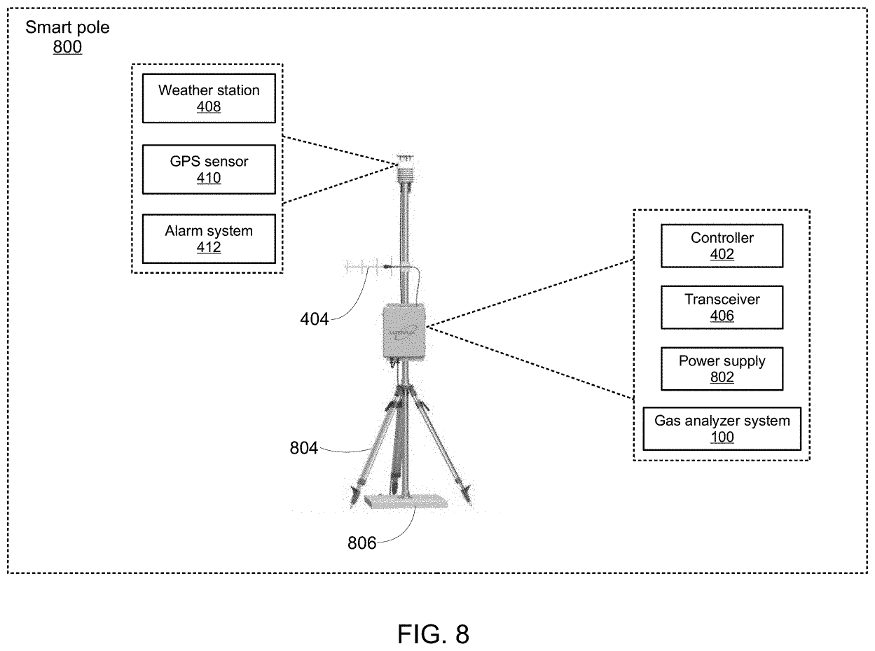

FIG. 8 shows a smart pole 800 for monitoring and tracking emissions at a site according to an exemplary embodiment. In this embodiment, the smart pole 800 embodies components of the emission monitoring system 400, each component performing the same functions as earlier described. The smart pole 800 further consists of a power supply 802, collapsible tripod legs 804 and a flat base 806. The collapsible tripod legs 804 and the flat base 806 provides a sturdy platform and facilitates deployment of the smart pole 800 in any terrain. The detection range of the smart pole is 200×200 m². For large industrial sites, e.g. oil and gas plants or wastewater plants, a plurality of smart poles are preferably deployed, wherein the number of deployable smart poles is dependent on model to be analyzed. When deployed at a site, the GPS sensor 410 reports to the controller 402, the location of the smart pole and the elevation at the particular site.

Furthermore, the controller 402 is capable of tracking a gas plume to derive information such as the source strength of emissions from the measured concentration using a dispersion model including air dispersion model, inverse dispersion model, atmospheric dispersion modelling, Calpuff software etc. The models are prestored on the storage device of the controller 402 and utilized by the processor when needed.

FIG. 9 illustrates a plurality of smart poles 800a, 800b, 800c deployed at a particular site according to an exemplary embodiment. Because the methane plume 900 is withing the detectable range of the smart poles 800a, 800b, 800c, each of the smart poles independently calculates the concentration of methane gas at the site.

Results from the measurements performed by each smart pole 800 is transmitted as radio waves to the base transceiver station 414. A central controller 902 coupled to the base transceiver station 414 receives the results of the measurements and further determines the emission flux of methane at the particular site by correlating the concentration of methane reported by each smart pole 800a, 800b, 800c with the area of the site covered by the plurality of smart poles.

In this embodiment, the central controller 902 is further coupled to a network 904 and uploads the results of measurements to the network 904. The network 904 in this embodiment is a cloud server that is accessible by a user. In other embodiments, each controller of the smart poles is configured to access the network 904, results from each smart pole can be directly uploaded to the network 904 without the need to send the results to the central controller via the base transceiver station. Yet having each smart pole send results to the central controller is beneficial in determining the emission flux within an area.

One advantage of deploying a plurality of smart poles is that accuracy of results is significantly improved by aggregating results from the plurality of smart poles. This is particularly beneficial considering that the concentration of a target gas measured depends on a number of factors, including proximity of the smart pole to the emission source, environmental conditions etc. In addition, each smart pole can be independently relocated or moved closed to an emission source if need be.

Examples of advantages of different embodiments of the invention include the following:
The emission monitoring system is low cost and portable.
Unlike existing systems, there is no need to temperature stabilize as temperature instability is accounted for by performing measurements in both light and dark operational modes.
The emission monitoring system is power efficient as the radiation source is only turned on for a short time. When operating the system in the light mode, the radiation source is generally held for at least 10 seconds to allow the filament heat up.
Since absorbance is limited by the wavelength of the incident light, in the preferred embodiments, the radiation source is a blackbody, which offers a broader wavelength spectrum. As such, measurements can be performed in the mid-IR range where most emission gases exhibit greater absorbance. In this manner, the sensitivity of the emission monitoring system of the preferred embodiments is superior that of existing systems, which operate in the near-IR regime where absorbance is low.
Ability to be deployed in extreme weather conditions. The sensitivity of the emission monitoring system of the preferred embodiments is not affected by temperature instability as temperature is accounted for by taking measurements in two operational modes.
Results are generated in real time, which eliminates the need to send measurements to a laboratory or data processing center to obtain results. Similarly, results are instantaneously uploaded to a cloud server, and ready to be accessed from any location.

Although the invention has been described in connection with preferred embodiments, it should be understood that various modifications, additions and alterations may be made to the invention by one skilled in the art without departing from the spirit and scope of the invention.

For example, while the filter array in the above embodiments are assumed to be fixed, in other embodiments the filter array is spinning wheel containing a plurality of filters, wherein each filter serves a particular bandwidth. In this manner, the scope of wavelengths probed can be varied as desirable by simply rotating the wheel toward a filter with the desired bandwidth.

Although the exemplary embodiment of FIG. 2 illustrates the four filters—four detector configuration, the number of filters and detectors can be scaled up or scaled down depending on the number of target gases to desired to be monitored simultaneously.

In some embodiments, the sound effects from the alarm system can be pre-configured for different gas concentration above the predetermined threshold value. Similarly, the alarm system can be pre-configured for visual effects only and/or a combination of audio and visual effects.

In some embodiments, the weather station is an ultrasonic weather station while in other embodiments it is a miniature weather station that can fit on top of the smart pole. Any other type of weather station may also be deployed without deviating from the scope of the invention.

In some embodiments, in order to avoid building up too much gas pressure inside the gas cell during the inflow process, the controller 402 may be configured to set the time duration for which the compressor 118 should be activated or may further limit a maximum time duration for which the compressor 118 can be activated at step 606. Likewise, the controller 402 may also be configured to limit a maximum amount of time that the reference detector can take to reach the threshold value at step 614. In the event that the maximum allowed time durations are reached at either of steps 606 and/or 614, an error message may be transmitted to a remote administrator.

In some embodiments, the controller 402 is configured to output to a display device charts of the intensity versus concentration of the target gas. This is useful as it provides a visual of the measurement performed by the emission monitoring system.

In some embodiments, rather than first performing measurements in dark mode and later in the light mode, the order in which the measurements are performed is switched. In these embodiments, the measurement in the light mode precedes that in the dark mode. This is advantageous as the IR light that lingers after the radiation source is turned off may be utilized to perform measurements in the dark mode, thus increasing the amplitude of the signal detected when the gas analyzer system is operated in the dark mode.

While it is stated in the above preferred embodiments that a signal generated in the dark mode is processed along Path I, while a signal generated in the light mode is processed along Path II, in some embodiments the order may be reversed without deviating from the scope of the invention. In such embodiments, the signal generated in the light mode is processed through Path I while the signal generated in the dark mode is processed along Path II.

In some embodiments, the emission monitoring system may include a power source such as rechargeable battery that is coupled to a solar panel.

The modules may be implemented by software executed by one or more processors operating pursuant to instructions stored on a tangible computer-readable medium such as a storage device to perform the above-described functions of any or all aspects of the controller 402. Examples of the tangible computer-readable medium include optical media (e.g., CD-ROM, DVD discs), magnetic media (e.g., hard drives, diskettes), and other electronically readable media such as flash storage devices and memory devices (e.g., RAM, ROM). The computer-readable medium may be local to the computer executing the instructions, or may be remote to this computer such as when coupled to the computer via a computer network such as the Internet. The processors may be included in a general-purpose or specific-purpose computer that becomes the controller 402 or any of the above-described modules as a result of executing the instructions.

In other embodiments, rather than being software modules executed by one or more processors, the modules may be implemented as hardware modules configured to perform the above-described functions. Examples of hardware modules include combinations of logic gates, integrated circuits, field programmable gate arrays, and application specific integrated circuits, and other analog and digital circuit designs.

Functions of single modules may be separated into multiple units, or the functions of multiple modules may be combined into a single unit.

Unless otherwise specified, features described may be implemented in hardware or software according to different design requirements. In addition to a dedicated physical computing device, the word “server” may also mean a service daemon on a single computer, virtual computer, or shared physical computer or computers, for example. All combinations and permutations of the above described features and embodiments may be utilized in conjunction with the invention.

What is claimed is:

1. An emission monitoring device for measuring a concentration of a target gas, the emission monitoring device comprising:
a gas cell;
a radiation source;
a detector;
a readout circuit coupled to the detector; and
a controller coupled to the radiation source and the readout circuit, wherein the controller is configured to:
cause the radiation source to enter a first operational mode;
cause the readout circuit to sample and hold a first output signal of the detector while the radiation source is operating in the first operational mode;
cause the radiation source to exit the first operational mode and enter into a second operational mode;
cause the readout circuit to obtain a difference between the first output signal and a second output signal of the detector, the second output signal of the detector being detected while the radiation source is operating in the second operational mode; and
convert the difference between the first output signal and the second output signal into an output value representing the concentration of the target gas.

2. The emission monitoring device of claim 1, wherein the concentration of the target gas is obtained by correlating the output value to a predetermined value for a known gas.

3. The emission monitoring device of claim 1, wherein the radiation source is a blackbody that emits infrared light (IR).

4. The emission monitoring device of claim 1, wherein:
the first operational mode corresponds to when the radiation source is turned on; and
the second operational mode corresponds to when the radiation source is turned off.

5. The emission monitoring device of claim 1, wherein:
the first operational mode corresponds to when the radiation source is turned off; and
the second operational mode corresponds to when the radiation source is turned on.

6. The emission monitoring device of claim 5, wherein the second operational mode is activated after radiation source has been turned on for a predetermined time duration of at least ten seconds.

7. The emission monitoring device of claim 1, wherein the controller is further configured to cause the radiation source to periodically toggle between the first operational mode and the second operational mode.

8. The emission monitoring device of claim 1, further comprising a plurality of detectors.

9. The emission monitoring device of claim 8, wherein the gas cell is cylindrical in shape and the plurality of detectors are symmetrical placed relative to a centre of a cross section of the gas cell.

10. The emission monitoring device of claim 1, wherein the readout circuit comprises:
a first operational amplifier;
a second operational amplifier;
a sample-and-hold circuit coupled to the first operational amplifier;
a first buffer amplifier coupled to the first operational amplifier and the second operational amplifier;
a second buffer amplifier coupled to the second operational-amplifier and the sample-and-hold circuit; and
an analog-to-digital converter coupled to the second operational amplifier and the controller;
wherein the analog-to-digital converter is configured to:
receive an analog signal from the second operational amplifier;
convert the analog signal into a digital signal; and
send the digital signal to the controller for further analysis.

11. The emission monitoring device of claim 1, wherein the controller is further coupled to a transceiver through which the controller sends the concentration of the target gas to a base transceiver station.

12. The emission monitoring device of claim 1, wherein the controller is configured to activate an alarm system in response to determining that the concentration of the target gas is greater than a predetermined threshold value.

13. The emission monitoring device of claim 1, further comprising:
a compressor at an inlet of the gas cell;
a back pressure valve at an outlet of the gas cell; and
a pressure sensor within the gas cell;
wherein the controller is further configured to:
close the back pressure valve to thereby prevent gas within the gas cell from existing via the outlet;
activate the compressor to add gas to the gas cell via the inlet;
monitor a pressure within the gas cell according a signal received from the pressure sensor; and
cause the readout circuit to sample and hold the first output signal of the detector while the radiation source is operating in the first operational mode and cause the radiation source to exit the first operational mode and enter into the second operational mode in response to the pressure within the gas cell reaching a predetermined threshold.

14. The emission monitoring device of claim 1, further comprising:
a reference detector for detecting a wavelength of light that is not absorbed by any gas within the gas cell;
wherein the controller is further configured to read the second output signal of the detector in response to detecting the reference detector reaching a threshold level while the radiation source is operating in the second operational mode.

15. A system comprising a plurality of the emission monitoring device of claim 1, wherein the system is deployed at a geographic location for measuring the concentration of one or more target gases that is present at the geographic location.

16. A method of measuring a concentration of a target gas within a gas cell, the method comprising:
causing a radiation source to enter a first operational mode;
causing a readout circuit to sample and hold a first output signal of a detector coupled to the readout circuit while the radiation source is operating in the first operational mode;
causing the radiation source to exit the first operational mode and enter into a second operational mode;
causing the readout circuit to obtain a difference between the first output signal and a second output signal of the detector, the second output signal of the detector being detected while the radiation source is operating in the second operational mode; and
converting the difference between the first output signal and the second output signal into an output value representing the concentration of the target gas.

17. The method of claim 16, wherein the concentration of the target gas is obtained by correlating the output value to a predetermined value for a known gas.

18. The method of claim 16, wherein:
the first operational mode corresponds to when the radiation source is turned off; and
the second operational mode corresponds to when the radiation source is turned on.

19. The method of claim 16, further comprising:
closing a back pressure valve at an outlet of the gas cell to thereby prevent gas within the gas cell from existing via the outlet;
activating a compressor at an inlet of the gas cell to add gas to the gas cell via the inlet;
monitoring a pressure within the gas cell according a signal received from a pressure sensor within the gas cell; and
causing the readout circuit to sample and hold the first output signal of the detector while the radiation source is operating in the first operational mode and causing the radiation source to exit the first operational mode and enter into the second operational mode in response to the pressure within the gas cell reaching a predetermined threshold.

20. A non-transitory processor-readable medium comprising a plurality of processor-executable instructions that when executed by one or more processors cause the one or more processors to perform steps of:
causing a radiation source to enter a first operational mode;
causing a readout circuit to sample and hold a first output signal of a detector coupled to the readout circuit while the radiation source is operating in the first operational mode;
causing the radiation source to exit the first operational mode and enter into a second operational mode;
causing the readout circuit to obtain a difference between the first output signal and a second output signal of the detector, the second output signal of the detector being detected while the radiation source is operating in the second operational mode; and
converting the difference between the first output signal and the second output signal into an output value representing a concentration of a target gas.
